(19) United States
(12) Patent Application Publication
(10) Pub. No.: US 2017/0064418 A1
(43) Pub. Date: Mar. 2, 2017

(54) WAVELENGTH SWITCHING METHOD, APPARATUS, AND SYSTEM

(71) Applicant: Huawei Technologies Co., Ltd., Shenzhen (CN)

(72) Inventors: Minghui TAO, Wuhan (CN); Shengping LI, Wuhan (CN)

(21) Appl. No.: 15/349,754

(22) Filed: Nov. 11, 2016

Related U.S. Application Data
(63) Continuation of application No. PCT/CN2014/077214, filed on May 12, 2014.

(51) Int. Cl. H04Q 11/00; H04B 10/27; H04J 14/02

(52) U.S. Cl. CPC H04Q 11/0005; H04Q 11/0062; H04J 14/0242; H04B 10/27; H04Q 2011/0016; H04Q 2011/0086; H04B 10/503

(57) ABSTRACT

A wavelength switching method, apparatus, and system are disclosed. The method includes: encapsulating a logical link identifier (LLID) of an optical network unit (ONU) and a wavelength allocated to the ONU into a first Multi-Point Control Protocol (MPCP) message, and sending the first MPCP message to the ONU, for the ONU to perform switching according to the wavelength. In this manner, a problem of how to implement wavelength switching in a next-generation Ethernet passive optical network (NG-EPON) is resolved.

### CROSS-REFERENCE TO RELATED APPLICATIONS

This application is a continuation of International Application No. PCT/CN2014/077214, filed on May 12, 2014, the disclosure of which is hereby incorporated by reference in its entirety.

### TECHNICAL FIELD

The present disclosure relates to the communications field, and in particular, to a wavelength switching method, apparatus, and system.

### BACKGROUND

A passive optical network (PON) is a system providing “the last mile” network access. The PON is a point-to-multipoint network, including an optical line terminal (OLT) located in a central office, an optical distribution network (ODN), and multiple optical network units (ONUs) located in a customer premise. In some PON systems, for example, in an Ethernet passive optical network (Ethernet PON, or EPON) system, a downlink wavelength is 1490 nanometer nm, and an uplink wavelength is 1310 nm; and in a 10G-EPON, a downlink wavelength is 1577 nm, an uplink wavelength is 1270 nm, and both the uplink wavelength and the downlink wavelength are in a single wavelength form. When a next-generation EPON (Next Generation EPON, or NG-EPON) uses a multi-wavelength manner, there is no solution about how to complete wavelength switching in the prior art.

### SUMMARY

The present disclosure provides a wavelength switching method, apparatus and system, so as to resolve a problem of how to implement wavelength switching in an NG-EPON.

To achieve the foregoing objective, the following technical solutions are used in the present disclosure:

According to a first aspect, a wavelength switching method includes: encapsulating a logical link identifier LLID of an optical network unit ONU and a wavelength allocated to the ONU into a first Multi-Point Control Protocol MPCP message, and sending the first MPCP message to the ONU, for the ONU to perform switching according to the wavelength.

With reference to the first aspect, in a first possible implementation manner, the method further includes: sending a second MPCP message to the ONU, where the second MPCP message carries an identifier instructing the optical network unit ONU to perform wavelength switching and wavelength switching window information.

With reference to the first possible implementation manner of the first aspect, in a second possible implementation manner, the identifier instructing the ONU to perform wavelength switching is specifically that any reserved bit of a discovery information Discovery Information field of a Multi-Pont Control Protocol MPCP GATE message is set to 1.

With reference to the first possible implementation manner or the second possible implementation manner of the first aspect, in a third possible implementation manner, the identifier instructing the ONU to perform wavelength switching is specifically that the Discovery Information field of the MPCP GATE message is set to a specific value.

With reference to the first aspect, in a fourth possible implementation manner, the method further includes: receiving a response message of the second MPCP message, where the response message is carried in a third MPCP message, and the response message carries the LLID of the ONU.

With reference to the first possible implementation manner of the first aspect, in a fifth possible implementation manner, the wavelength switching request message further carries wavelength adjustment performance information of a laser of the ONU

With reference to the second possible implementation manner of the first aspect, in a sixth possible implementation manner, the response message further carries current wavelength information of a laser of the ONU.

With reference to the sixth possible implementation manner of the first aspect, in a seventh possible implementation manner, the response message further carries at least one of the following information: a wavelength adjustable range of the laser of the ONU or a wavelength adjustment speed of the laser of the ONU.

According to a second aspect, a wavelength switching method includes: receiving a first Multi-Point Control Protocol MPCP message sent by an optical line terminal OLT, the first MPCP message carries a logical link identifier LLID of an optical network unit ONU and a wavelength allocated to the ONU; and determining whether the wavelength allocated to the ONU and a current wavelength of the ONU are the same, and if not, adjusting the wavelength of the ONU to the wavelength allocated to the ONU.

With reference to the second aspect, in a first possible implementation manner of the second aspect, before the receiving a Multi-Point Control Protocol MPCP message sent by an optical line terminal OLT, the method further includes: receiving a second MPCP message that is sent by the OLT and that instructs the ONU to perform wavelength switching; and

encapsulating the LLID of the ONU into a third Multi-Point Control Protocol MPCP message, and sending the third MPCP message to the OLT.

With reference to the first possible implementation manner of the second aspect, in a second possible implementation manner of the second aspect, the third MPCP message further carries a current wavelength of a laser of the ONU.

With reference to the first possible implementation manner or the second possible implementation manner of the second aspect, in a third possible implementation manner, the third MPCP message further carries at least one of the following information: a wavelength adjustable range of the laser of the ONU or a wavelength adjustment speed of the laser of the ONU.

With reference to any one of the second aspect or the possible implementation manners of the second aspect, in a fourth possible implementation manner, the method further includes: sending a fourth MPCP message to the OLT, where the fourth MPCP message carries an adjusted wavelength of the ONU.

According to a third aspect, a wavelength switching apparatus includes: a processor, configured to: encapsulate an ONU identifier of an ONU whose wavelength needs to be switched and a wavelength allocated to the ONU into a first Multi-Point Control Protocol MPCP message, and send the first MPCP message to the ONU whose wavelength needs to be switched, for the ONU to perform switching according to the wavelength.

With reference to the third aspect, in a first possible implementation manner of the third aspect, the processor is configured to: receive a second MPCP message, where the second MPCP message carries the ONU identifier of the ONU whose wavelength needs to be switched and wavelength adjustment performance information of a laser of the ONU; determine, according to the wavelength adjustment performance information of the laser of the ONU, the wavelength allocated to the ONU; and encapsulate an LLID of the ONU and the determined wavelength allocated to the ONU into the first MPCP message, and send the first MPCP message to the ONU, for the ONU to perform switching according to the wavelength.

With reference to the third aspect, in a second possible implementation manner of the third aspect, the processor is further configured to send a third MPCP message, where the third MPCP message carries an identifier instructing the optical network unit ONU to perform wavelength switching and wavelength switching window information.

With reference to the third aspect or either of the possible implementation manners of the third aspect, in a third possible implementation manner, the wavelength adjustment performance information of the laser of the ONU is specifically current wavelength information of the laser of the ONU.

With reference to the third possible implementation manner of the third aspect, in a fourth possible implementation manner, the wavelength adjustment performance information of the laser of the ONU further includes at least one of the following information: a wavelength adjustable range of the laser of the ONU and a wavelength adjustment speed of the laser of the ONU.

According to a fourth aspect, a wavelength switching apparatus includes: a processor, configured to: receive a first Multi-Point Control Protocol MPCP message sent by an optical line terminal OLT, where the first MPCP message carries a logical link identifier LLID of an optical network unit ONU and a wavelength allocated to the ONU; and determine whether the wavelength allocated to the ONU and a current wavelength of the ONU are the same, and if not, adjust the wavelength of the ONU to the wavelength allocated to the ONU.

With reference to the fourth aspect, in a first possible implementation manner of the fourth aspect, the processor is further configured to: receive a second MPCP message that is sent by the OLT and that instructs the ONU to perform wavelength switching; and encapsulate the LLID of the ONU into a third Multi-Point Control Protocol MPCP message, and send the third MPCP message to the OLT.

With reference to the fourth aspect, in a second possible implementation manner of the fourth aspect, the third MPCP message further carries a current wavelength of a laser of the ONU.

With reference to the fourth aspect or either of the possible implementation manners of the fourth aspect, the third MPCP message further carries at least one of the following information: a wavelength adjustable range of the laser of the ONU or a wavelength adjustment speed of the laser of the ONU.

With reference to the third possible implementation manner of the fourth aspect, in a fourth possible implementation manner, the processor is further configured to send a fourth MPCP message to the OLT, where the fourth MPCP message carries an adjusted wavelength of the ONU.

According to a fifth aspect, a wavelength switching apparatus includes: a processing unit, configured to encapsulate a logical link identifier LLID of an optical network unit ONU and a wavelength allocated to the ONU into a first Multi-Point Control Protocol MPCP message; and a sending unit, configured to send the MPCP message to the ONU.

With reference to the fifth aspect, in a first possible implementation manner of the fifth aspect, the processing unit is further configured to send a second MPCP message to the ONU, where the second MPCP message carries an identifier instructing the optical network unit ONU to perform wavelength switching and wavelength switching window information.

With reference to the first possible implementation manner of the fifth aspect, in a second possible implementation manner of the fifth aspect, the apparatus further includes: a receiving unit, configured to receive a response message of the second MPCP message, where the response message is carried in a third MPCP message, and the response message carries the logical link identifier LLID of the ONU.

With reference to the second possible implementation manner of the fifth aspect, in a third possible implementation manner of the fifth aspect, the response message further carries current wavelength information of a laser of the ONU.

With reference to the second or third possible implementation manner of the fifth aspect, in a fourth possible implementation manner of the fifth aspect, the response message further carries at least one of the following information: a wavelength adjustable range of the laser of the ONU and a wavelength adjustment speed of the laser of the ONU.

According to a sixth aspect, a wavelength switching apparatus includes: a receiving unit, configured to receive a first Multi-Point Control Protocol MPCP message sent by an optical line terminal OLT, where the first MPCP message carries a logical link identifier LLID of an optical network unit ONU and a wavelength allocated to the ONU; and a processing unit, configured to: determine whether the wavelength allocated to the ONU and a current wavelength of the ONU are the same, and if not, adjust the wavelength of the ONU to the wavelength allocated to the ONU.

With reference to the sixth aspect, in a first possible implementation manner, the receiving unit is further configured to receive a second MPCP message that is sent by the OLT and that instructs the ONU to perform wavelength switching; and the processing unit is further configured to: encapsulate the LLID of the ONU into a third Multi-Point Control Protocol MPCP message, and send the third MPCP message to the OLT.

With reference to the sixth aspect, in a second possible implementation manner, the third MPCP message further carries a current wavelength of a laser of the ONU.

With reference to the sixth aspect, in a third possible implementation manner, the third MPCP message further carries at least one of the following information: a wavelength adjustable range of the laser of the ONU or a wavelength adjustment speed of the laser of the ONU.

With reference to any one of the sixth aspect or the possible implementation manners of the sixth aspect, in a fourth possible implementation manner, the apparatus further includes a sending unit, configured to send a fourth MPCP message to the OLT, where the fourth MPCP message carries an adjusted wavelength of the ONU.

According to a seventh aspect, an optical line terminal includes a processor, where the processor includes the apparatus according to the fifth aspect and any one of the possible implementation manners of the fifth aspect.

According to an eighth aspect, an optical network unit includes a processor, where the processor includes the apparatus according to the sixth aspect and any one of the possible implementation manners of the sixth aspect.

According to a ninth aspect, a passive optical network system includes an optical line terminal OLT and an optical network unit ONU, where the optical line terminal OLT is connected to at least one ONU by using an optical distribution network ODN, where the OLT includes the apparatus according to the seventh aspect, or the ONU includes the apparatus according to the eighth aspect.

Embodiments of the present disclosure provide a wavelength switching method, apparatus, and system, so that a problem of how to perform wavelength switching can be resolved when an NG-EPON uses a multi-wavelength networking structure.

### BRIEF DESCRIPTION OF DRAWINGS

To describe the technical solutions in the embodiments of the present disclosure or in the prior art more clearly, the following briefly describes the accompanying drawings required for describing the embodiments or the prior art. Apparently, the accompanying drawings in the following description show merely some embodiments of the present disclosure, and a person of ordinary skill in the art may still derive other drawings from these accompanying drawings without creative efforts.

FIG. 1 is a schematic diagram of an embodiment of a PON;

FIG. 2 is a diagram of an Open System Interconnection OSI model;

FIG. 3 is an MPCP frame format according to an embodiment of the present disclosure;

FIG. 4 is a schematic diagram of an embodiment of an NG-EPON architecture;

FIG. 5 is a schematic diagram of another embodiment of an NG-EPON architecture;

FIG. 6A is a schematic interaction diagram of an NG-EPON wavelength switching process;

FIG. 6B is a schematic diagram of implementation of a wavelength switching process according to an embodiment of the present disclosure;

FIG. 6C is a block diagram of definition of an MPCP frame message in the prior art;

FIG. 7A is a schematic diagram of an embodiment of GATE message extension;

FIG. 7B is a schematic diagram of definition of a WaveRegister Information field;

FIG. 8 is a schematic diagram of an embodiment of three newly added MPCP messages used for wavelength initialization according to an embodiment of the present disclosure;

FIG. 9 is a schematic diagram of a specific frame structure of three newly added MPCP messages used for wavelength initialization according to an embodiment of the present disclosure;

FIG. 10 is a schematic structural diagram of a wavelength switching apparatus according to an embodiment of the present disclosure;

FIG. 11 is a schematic structural diagram of another wavelength switching apparatus according to an embodiment of the present disclosure; and

FIG. 12 is a schematic structural diagram of another wavelength switching apparatus according to an embodiment of the present disclosure.

### DESCRIPTION OF EMBODIMENTS

The following clearly describes the technical solutions in the embodiments of the present disclosure with reference to the accompanying drawings in the embodiments of the present disclosure. Apparently, the described embodiments are merely some but not all of the embodiments of the present disclosure. All other embodiments obtained by a person of ordinary skill in the art based on the embodiments of the present disclosure without creative efforts shall fall within the protection scope of the present disclosure.

In addition, the terms “system” and “network” may be interchangeably used in this specification. The term “and/or” in this specification describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

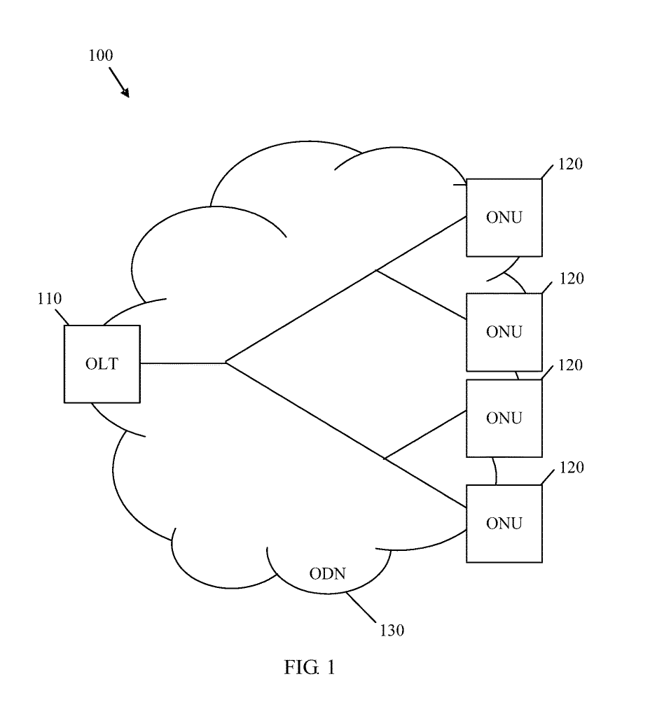

FIG. 1 shows an embodiment of a PON 100. The PON 100 may include one OLT 110, multiple ONUs 120, and one ODN 130. The ODN 130 may be coupled to the OLT 110 and each ONU 120. The PON 100 may be a communications network that does not need any active component to distribute data between the OLT 110 and each ONU 120. On the contrary, the PON 100 may use a passive optical component to distribute data between the OLT 110 and each ONU 120 in the ODN 130. The PON 100 may be an NGA (Next Generation Access) system, for example, an XGPON (10 Gigabit PON, which may also be referred to as 10-gigabit passive optical network), which may have a downlink bandwidth of approximately 10 Gbps and an uplink bandwidth of at least approximately 2.5 Gbps, or may be a 10G-EPON (10 Gigabit Ethernet PON, 10-gigabit Ethernet passive optical network). Another example suitable to the PON 100 includes an Asynchronous Transfer Mode PON (APON) and a broadband PON (BPON) that are defined by the International Telecommunication Union-Telecommunication Standardization Sector (ITU-T) G983 standard, a GPON defined by the ITU-T G.984 standard, an EPON defined by the Institute of Electrical and Electronics Engineers (IEEE) 802.3ah standard, a 10GEPON described in the IEEE 802.3av standard, and a wavelength division multiplexing PON (WDM-PON). In addition, the PON 100 may further have a multi-wavelength capability, where multiple downlink and/or uplink wavelengths (or wavelength channels) may be used to carry data, for example, carry data for different ONUs 120 or a customer. Therefore, a PON protocol may be used to support any multi-wavelength technology/system above.

The OLT 110 may be any device configured to communicate with each ONU 120 and another network (not shown in the figure). The OLT 110 may play a role of a medium between the another network and each ONU 120. For example, the OLT 110 may forward data received from the network to each ONU 120, and forward data received from each ONU 120 to the another network. Although a specific configuration of the OLT 110 may be changed according to a type of the PON 100, in an embodiment, the OLT 110 may include a transmitter and a receiver. When the another network uses a network protocol that is different from the PON protocol in the PON 100, for example, the Ethernet or synchronous optical network (SONET)/the synchronous digital hierarchy (SDH), the OLT 110 may include a converter that converts the network protocol to the PON protocol. The converter of the OLT 110 may further convert the PON protocol to the network protocol. The OLT 110 may be generally disposed in a central position, for example, a central office, or may be disposed in another position.

Each ONU 120 may be any device configured to communicate with the OLT 110 and a customer or a user (not shown in the figure). Each ONU 120 may play a role of a medium between the OLT 110 and the customer. For example, each ONU 120 may forward data received from the OLT 110 to the customer, and forward data received from the customer to the OLT 110. Although a specific configuration of each ONU 120 may be changed according to the type of the PON 100, in an embodiment, each ONU 120 may include an optical transmitter configured to send an optical signal to the OLT 110 and an optical receiver configured to receive an optical signal from the OLT 110. Transmitters and receivers of different ONUs 120 may use different wavelengths to send and receive an optical signal carrying data. A transmitter and a receiver of a same ONU 120 may use a same wavelength or different wavelengths. In addition, each ONU 120 may include: a converter converting an optical signal to an electrical signal, for example, a signal in an Ethernet protocol, for the customer, and a second transmitter and/or receiver that may send and/or receive an electrical signal for customer equipment. In some embodiments, each ONU 120 and each optical network terminal (ONT) are similar, and therefore, these terms may be interchangeably used in this specification. Each ONU may be generally disposed in an allocated position, for example, a customer premise, or may be disposed in another position.

The ODN 130 may be a data distribution system, which may include an optical fiber cable, a coupler, a splitter, a distributer, and/or another device. The optical fiber cable, the coupler, the splitter, the distributer, and/or the another device may be passive optical components/a passive optical component, and the passive optical component may not need any electric energy to distribute a data signal between the OLT 110 and each ONU 120. Alternatively, the ODN 130 may include one or more processing devices, for example, an optical amplifier. The ODN 130 may generally extend from the OLT 110 to each ONU 120 by using a branch configuration shown in FIG. 1, but another option may be that extension may be performed in a configuration form from any another point to multiple points.

Different PON systems supporting a bit rate greater than 10 Gbps are already put forward to be applied to a next generation PON (NGPON) system (also referred to as a NGPON stage 2, or an NGPON2). Some of these systems may be multi-wavelength PON systems that transmit and/or receive data for multiple ONUs by using multiple wavelengths (or wavelength channels).

Multiple wavelengths may provide a higher access speed. Using multiple wavelengths may improve a capacity of a time wavelength division multiplexing (TWDM) PON in a wavelength domain. In a TWDM-PON system, an ONU may be connected to a network by using different wavelengths, which may be implemented by using wavelength adjustability of the ONU or an OLT, by combining and separating wavelengths by using an AWG, by generating and detecting a coherent signal, by means of injection locking or by using another solution. The wavelength adjustability represents an adjustable wavelength range of the ONU.

Depending on an application scenario, implementation of the NGPON system may also be a hybrid of the foregoing systems. For example, a coherent wavelength division multiplexing passive optical network (Wavelength PON, or WDM-PON), a TWDM-PON, and an orthogonal frequency division multiplexing passive optical network (OFDM-PON) may be configured to implement several systems in the NGPON system. This trend may represent further improvement of an existing TDM-PON bandwidth. For example, the trends allow the NGPON system to serve more ONUs at a further distance. The improvement from the GPON and the XGPON system to the NGPON may challenge an existing protocol of the GPON and the XGPON, for example, from the perspective of an appropriate management mechanism supporting multiple wavelengths. A change and improvement of the protocol to support a multi-wavelength capability may include: a change of a GPON transmission convergence layer protocol and a change of an XGPON transmission convergence layer protocol, for example, management for TDM/TDM access (TDMA).

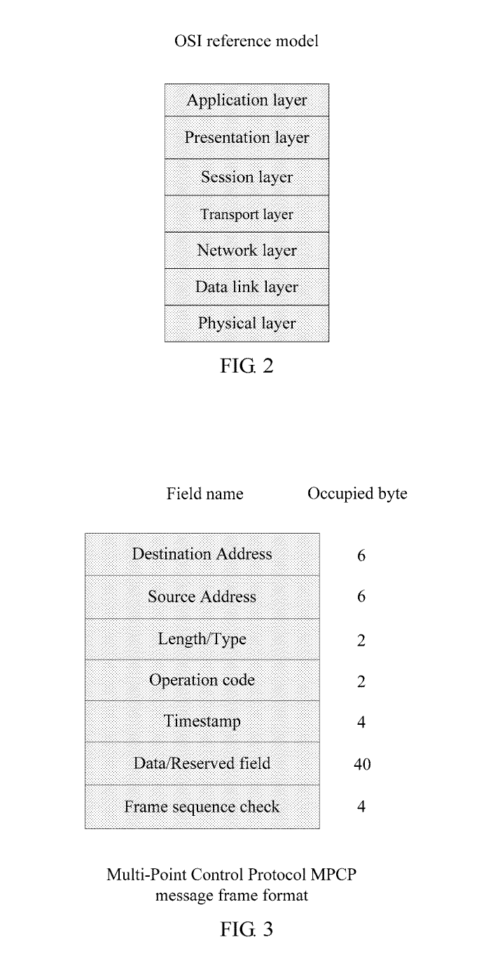

FIG. 2 discloses a detailed structural diagram of EPON (collectively referred to as a 1G EPON/10G EPON, which is subsequently used in this specification) OSI (Open Systems Interconnection). As shown in FIG. 2, the OSI divides network communication into seven layers, which are respectively (from the bottom to the top) a physical layer (PL layer), a data link layer (DL layer), a network layer (NL layer), a transport layer (LT layer), a session layer (SL layer), a presentation layer (PL layer), and an application layer (AL layer). The physical layer, the data link layer, and the network layer belong to three lower layers of an OSI reference model, and are responsible for creating a link for a network communication connection. The fourth layer to the seventh layer are four higher layers of the OSI reference model, and are specifically responsible for end-to-end data communication. Each layer completes a function, each layer directly provides a service to a layer higher than the layer, all the layers support each other, and network communication may be performed in two ways: from the up to the bottom (at a transmit end) or from the bottom to the up (at a receive end). Certainly, not all communication needs to use all the seven layers of the OSI, and even some communication only need a layer to which two sides correspond. Transit between physical interfaces and a connection between repeaters only needs to be performed in the physical layer, and a connection between routers only needs to use the three lower layers below the network layer. In summary, communication between two sides is performed in peer layers, and communication cannot be performed in asymmetrical layers.

Assuming that a signal is delivered from an OLT side to an ONU side, the signal sent from the OLT side (located in the Network layer in FIG. 2) enters the physical layer after passing through the DL layer in an Ethernet frame format, and then is transmitted to the ONU side by using an optical fiber, and the ONU side first analyzes data in the physical PHY layer, then analyzes data in a MAC (Media Access Control) layer, and finally extracts a useful signal of the ONU side. Because the EPON network performs point-to-multipoint transmission, a MAC layer, defined by the IEEE, of the EPON is multipoint MAC, and a transmission protocol of the multipoint MAC is defined as the MPCP (Multi-Point Control Protocol).

FIG. 3 is a schematic diagram of an MPCP frame format, as shown in FIG. 3:

Destination Address, a destination address, occupying six bytes, and used to identify an IP address to which the message is sent;

Source Address, a source address, occupying six bytes, and used to identify an IP address from which the packet is sent;

Length/Type, a packet length/type, occupying two bytes, and used to identify a length and a type of the packet;

Opcode, an operation code, occupying two bytes, and used to identify a number of the MPCP frame;

TimeStamp, a timestamp, occupying four bytes, and used to identify a sending time of the packet;

Data/Reserved/Pad, a data information/reserved field, occupying 40 bytes, and used to carry data information, or used as a reserved field for extension; and

FCS, a frame sequence check, occupying four bytes, a parity bit.

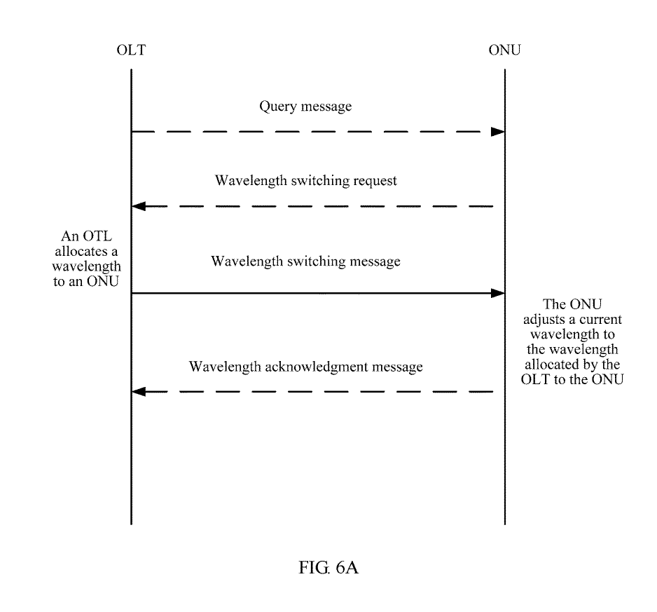

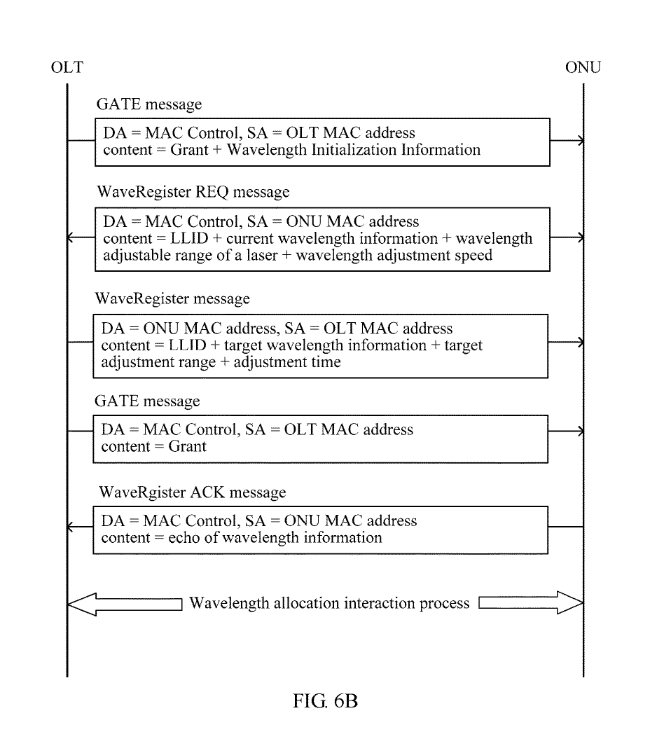

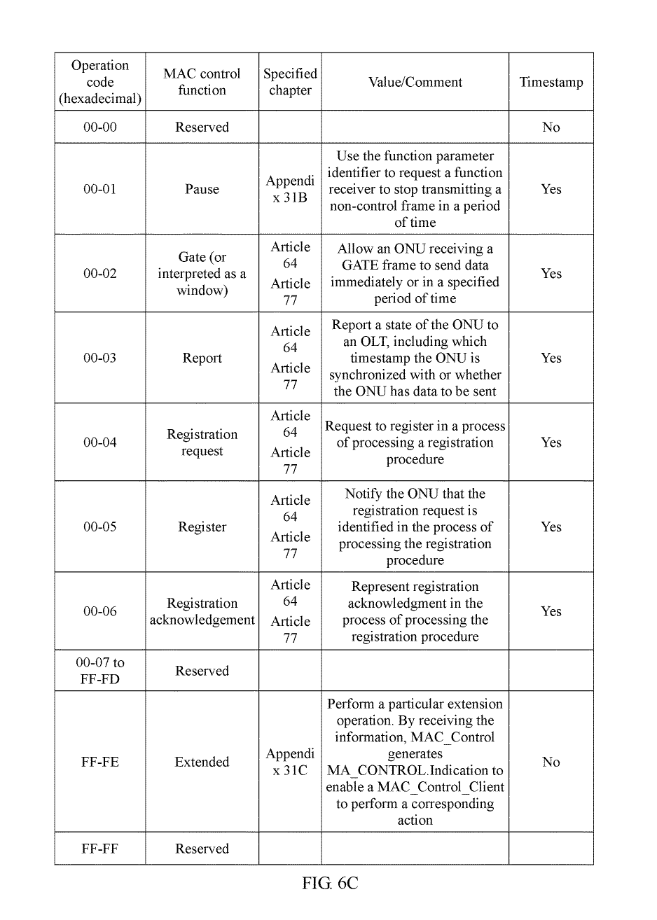

An existing standard records five types of MPCP frames, including a GATE frame, a REPORT frame, a REGISTER_REQ frame, a REGISTER frame, and a REGISTER_ACK frame. As shown in FIG. 6C (actually, the MPCP frame further have other types, and the other types are not described herein), all the five types of the frames include the foregoing fields, for example, the destination address, the source address, the length/type, the operation code, the timestamp, the data/reserved field, and the frame sequence check, and content of different frame fields are different. The Opcodes of the five types of frames are respectively 0002, 0003, 0004, 0005, and 0006.

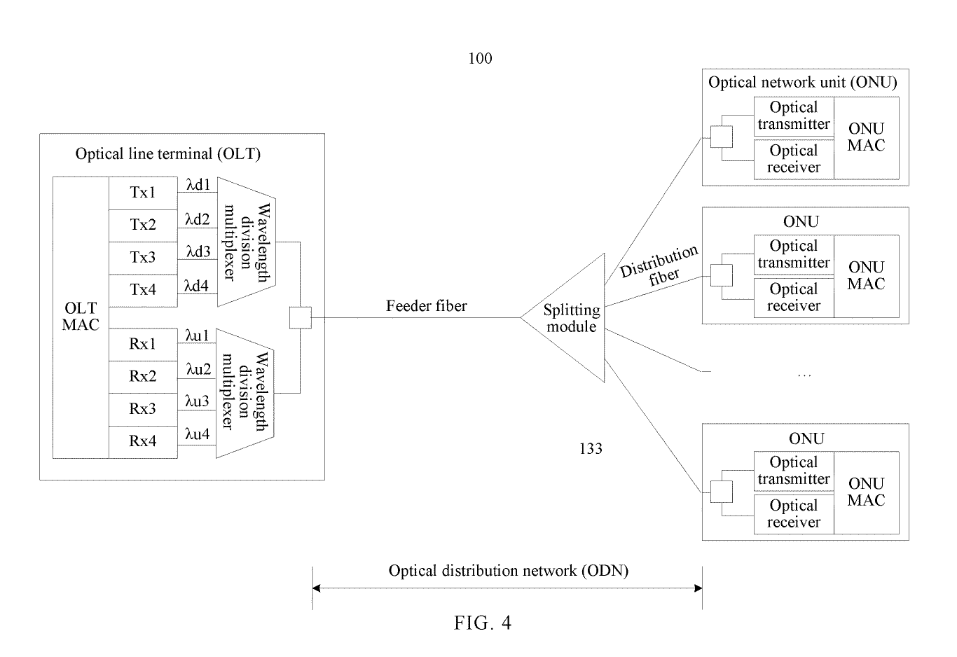

FIG. 4 is a specific embodiment of an NG-EPON networking structure. As shown in FIG. 4, an NG-EPON may use a system structure of using multiple waves at downlink and using multiple waves at uplink (in FIG. 4, an example in which four waves are used at uplink and four waves are used at downlink is used). In this networking structure, each ONU separately works in a wavelength channel, in a downlink direction, the OLT broadcasts, to multiple ONUs that use the wavelength channel, downlink data by using a downlink wavelength corresponding to each wavelength channel, and in an uplink direction, the ONU of each wavelength channel may send uplink data to the OLT by using an uplink wavelength of the wavelength channel in a timeslot allocated by the OLT. In addition, an uplink transmit wavelength and a downlink receive wavelength of the ONU may be dynamically adjusted, and when the uplink transmit wavelength and the downlink receive wavelength are adjusted to an uplink wavelength and a downlink wavelength of a wavelength channel, the ONUs may separately work in the wavelength channel.

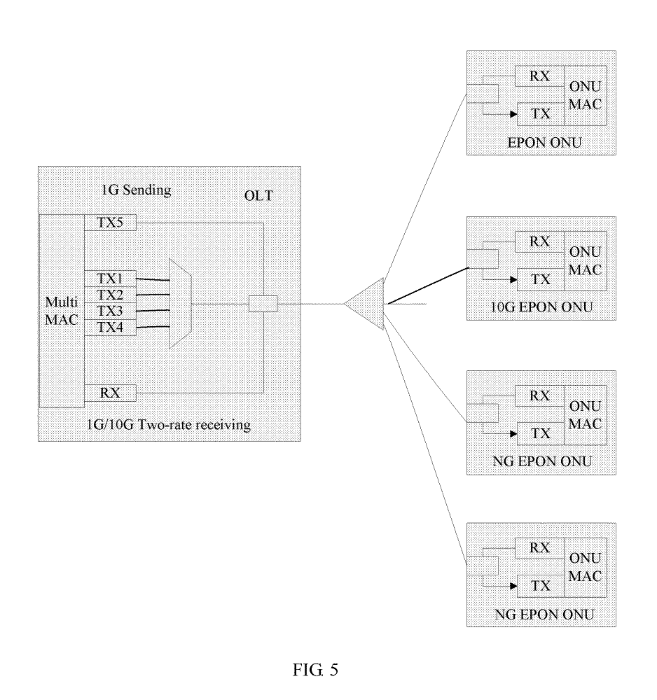

FIG. 5 is another specific embodiment of an NG-EPON networking architecture. FIG. 5 shows a system structure of using multiple waves at downlink and using a single wave at uplink (in FIG. 5, an example in which four waves are used at downlink and one wave is used at uplink is used). In the networking architecture, an OLT side includes five transmitters, where the first four transmitters Tx1 to Tx4 use a rate of 10 Gbps and different wavelengths, and the transmitter Tx5 performs sending at a rate of 1 Gbps, and uses a single wavelength. A receive side has only a two-rate receiver Rx that performs time-sharing processing on uplink data of different ONUs by means of time division multiplexing TDM. Receiving at uplink at different rates is performed by using a 1 Gbps/10 Gbps two-rate receiver, and receiving of uplink data of different ONUs are completed by using the two-rate receiver and the TDM.

An ONU side includes five ONUs, where the ONU1 to the ONU4 receive data of Tx1 to Tx4, a tunable filter is disposed in front of the receiver, and Tx1 to Tx4 may be differentiated by using the tunable filter. A fixed unified wavelength is used at uplink, which is differentiated by means of TDM. The ONUS is a 1 Gbps ONU whose uplink wavelength is consistent with that of another ONU and whose downlink wavelength is fixed, and receives a 1 Gbps signal sent by Tx5. The another ONU may be any one of the foregoing five ONUs.

During actual working, to implement load balancing (LB) between wavelength channels of the PON system, the OLT may need to instruct the ONU to perform wavelength switching in a working process of the ONU. For example, in an application scenario, when load of a wavelength channel A is excessively heavy, and a wavelength channel B is idle, the OLT may control, by using a wavelength switching instruction, some ONUs that originally work in the wavelength channel A to switch to the wavelength channel B in a manner of adjusting uplink transmit wavelengths and downlink receive wavelengths of the ONUs. In another application scenario, when a bandwidth of the wavelength channel A cannot meet a requirement of the ONU on a bandwidth, the ONU needs to switch to the another wavelength channel B having a relatively large bandwidth, the OLT may control, by using a wavelength switching instruction, the ONU to adjust the wavelength of the ONU, to be aligned with the wavelength channel B. In another application scenario, for the purpose of energy saving, the OLT switches the ONU to another wavelength channel, so as to save energy consumption for the OLT.

In a specific implementation manner, when an ONU performs a wavelength switching process, the OLT generally needs to first deliver a wavelength tuning instruction to the ONU, after receiving the tuning instruction, the ONU starts to tune, and the OLT waits until the ONU completes the switching process and keeps sending a command for querying whether the switching is completed. After completing the switching and receiving an authorization instruction of the OLT, the ONU sends a message indicating that “wavelength switching is already completed” to the OLT, after receiving a completion acknowledgment message sent by the ONU, the OLT starts to send timeslot authorization of downlink data and uplink data, and the like to the ONU, so that the OLT and the ONU recover normal service communication and send and receive uplink and downlink data.

Based on the embodiments of the NG-EPON networking structures shown in FIG. 4 and FIG. 5, when performing wavelength switching, the ONU may use a switching method shown in FIG. 6A. FIG. 6A shows an interaction process in which an OLT and an ONU perform wavelength switching, as shown in FIG. 6A:

The method includes: encapsulating, by an OLT, a logical link identifier LLID of an optical network unit ONU and a wavelength allocated to the ONU into a Multi-Point Control Protocol MPCP message, sending the MPCP message to the ONU, for the ONU to perform switching according to the wavelength.

Further, the MPCP message may further carry a target adjustment range, and the target adjustment range is used to instruct the ONU to adjust a wavelength range of a laser according to the target adjustment range.

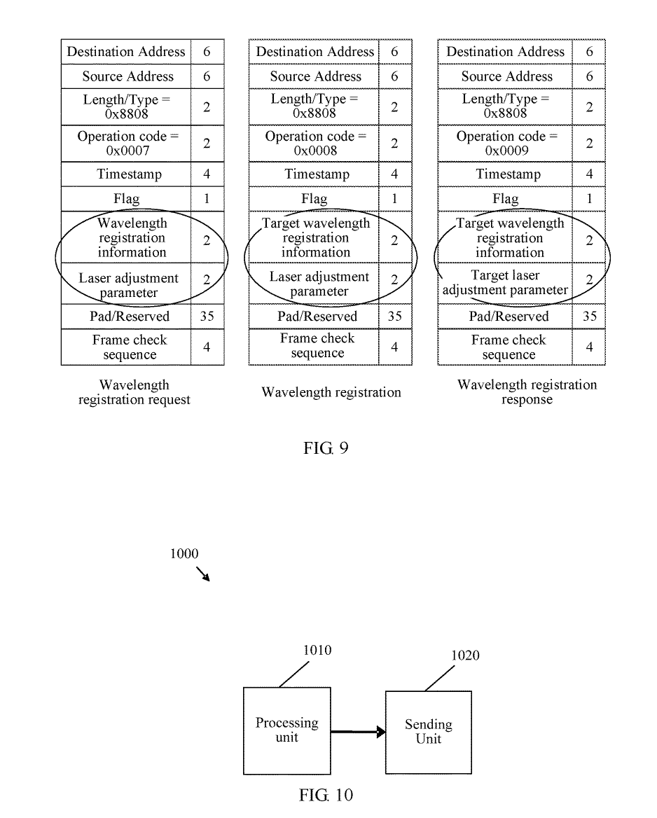

Specifically, a frame format of the MPCP message may be shown by a WaveRegister frame (a frame format in the middle of FIG. 9) in FIG. 9, an ONU identifier and the wavelength allocated to the ONU are carried in a reserved field of the MPCP message, and occupy one or more bits of the reserved field, or may be carried in a self-defined field, for example, an Echoed Waverigster Information field, and occupy one or more bits in two bytes. The target adjustment range may be carried in a Laser tuning Parameter field, and occupy one or more bits in two bytes. For another field of the WaveRegister frame, reference may be made to a record of an MPCP frame format in the prior art, and details are not described herein.

The OLT allocates a wavelength to the ONU. The OLT may preferentially select, according to a current wavelength resource status of the OLT, a wavelength resource from multiple wavelengths meeting a requirement of the ONU to allocate to the ONU, or arbitrarily selects a wavelength resource from multiple wavelengths meeting a requirement of the ONU to allocate to the ONU, or allocates according to another allocation algorithm in the prior art. That the OLT specifically uses which method to allocate a wavelength is not limited in this embodiment of the present disclosure.

The ONU identifier may be an ONU-ID defined in a standard, or may be a logical link ID (LLID) of the ONU, or may be another identifier that can uniquely identify the ONU.

The ONU receives the MPCP message, and determines whether a current wavelength is consistent with the wavelength allocated to the ONU, and if yes, the ONU does not adjust the wavelength, or if not, the ONU adjusts the wavelength of the ONU to the wavelength allocated by the OLT.

Further, the method further includes: after adjusting the wavelength, sending, by the ONU, a wavelength acknowledgment message to the OLT, where the wavelength acknowledgment message may also be carried by using an MPCP message (which is referred to as a second MPCP message to differentiate from the foregoing MPCP message). The second MPCP message carries adjusted wavelength information of the ONU, or may carry information, such as a laser performance parameter after the wavelength is adjusted.

Specifically, a frame format of the second MPCP message may be shown by a WaveRegister_ack message (a frame format in the right in FIG. 9) in FIG. 9, and the adjusted wavelength information of the ONU is carried in a reserved field of the MPCP message, and occupies one or more bits, or may be carried in a self-defined field, for example, the Echoed Waverigster Information field shown in FIG. 9, and occupy one or more bits in two bytes.

Optionally, the laser performance parameter after the wavelength is adjusted may be carried in the Laser tuning Parameter field, and is of two bytes, or may be carried in a reserved field of the MPCP frame.

The laser performance parameter may include an adjustment range of the laser or an adjustment speed of the laser, or another parameter that can reflect wavelength adjustment performance of the laser.

The method further includes: before sending a wavelength switching message, further sending, by the OLT, a query message, where the query message is carried by using a MPCP protocol, and is used to query whether the ONU needs to switch a wavelength (to differentiate, the MPCP message may be referred to as a third MPCP message).

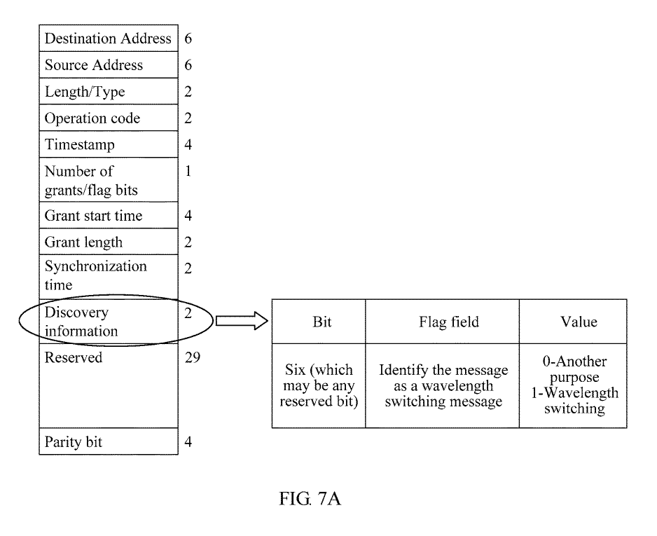

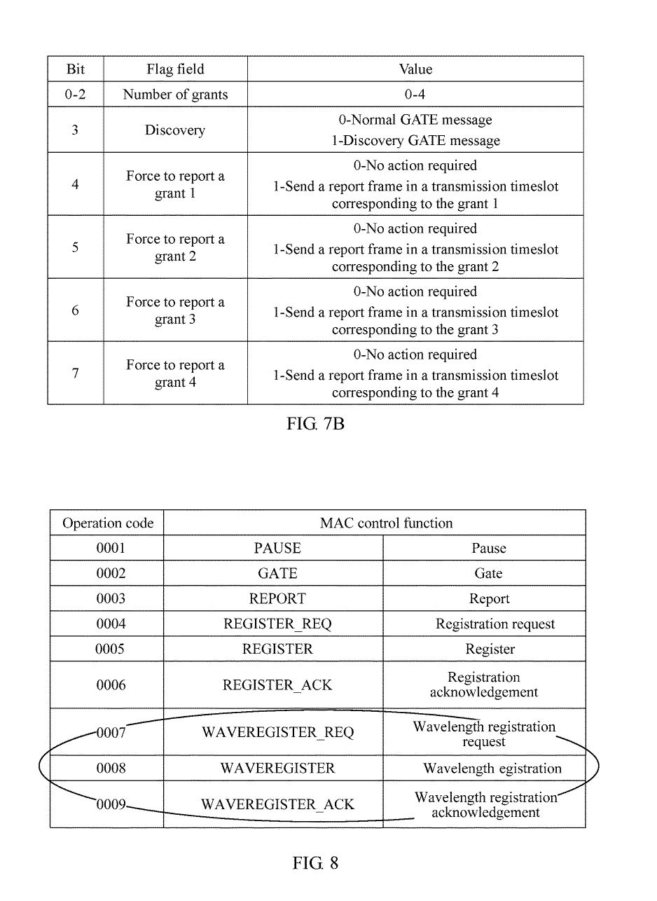

For a frame format of the query message, reference may be made to a GATE message in FIG. 7.

Specifically, the query message may use a frame format of a GATE message in the prior art, and a frame format of the GATE message may use a frame format shown in FIG. 7. A Discovery information field of the existing GATE message has a length of two bytes, that is, 16 bits in total, where as shown in FIG. 6A, bits 0 to 5 are respectively used to identify some information (not shown in the figure, referring to a record in an existing standard), bits 6 to 15 are a reserved field, and one or more bits are arbitrarily selected from the bits 6 to 15 to identify a type of the message. For example, when the six^{th} bit is 1, the six^{th} bit identifies that the GATE message is used for wavelength switching, or when the six^{th} bit is 0, the six^{th} bit identifies that the GATE message is used for another purpose.

The query message may be a unicast message, which is sent only to a particular ONU, or may be a broadcast message, which is sent to all ONUs. When receiving the query message, the ONU responds to the message and sends a wavelength switching request message, where the wavelength switching request message is carried by using an MPCP message (which is identified as a fourth MPCP message for differentiation). The message is the Waveregister_req message in FIG. 6B.

The Waveregister_req message carries an identifier used to uniquely identify the ONU, for example, the ONU identifier ONU-ID or the logical link identifier LLID (an LLID used in FIG. 6B), or may further carry a current wavelength of the ONU (current wavelength information used in FIG. 6B).

Further, the Waveregister_req message may further carry a performance parameter of a current laser of the ONU, for example, a wavelength adjustable range of the laser or a wavelength adjustment speed of the laser or another parameter related to wavelength adjustment.

The wavelength adjustable range of the laser is used to identify a wavelength range of the laser of the ONU, and the OLT may allocate a wavelength within this range to the ONU according to the wavelength adjustable range of the laser reported by the ONU. The wavelength adjustment speed is used to identify an amplitude or a speed of wavelength adjustment of the laser of the ONU, for example, a wavelength adjustment amplitude of the laser of the ONU is 1 nanometer nm, that is, the laser of the ONU increases the wavelength by an amplitude of 1 nm each time, until an adjusted wavelength is the wavelength allocated by the OLT to the ONU. The wavelength adjustment speed may provide reference for the OLT about how long the ONU completes a wavelength adjustment action.

It is worthy to note that, when the wavelength allocated by the OLT to the ONU is not within the wavelength adjustable range of the ONU, the ONU does not perform wavelength switching.

Specifically, the Waveregister_req message may use a Waveregister_req frame format (a frame format in the left in FIG. 9) in FIG. 9. The ONU identifier and the current wavelength information of the ONU may be carried in a Wave Register Information field, and use two bytes, and may occupy one or more bits in the two bytes; and the performance parameter of the laser of the ONU may be carried in a Laser tuning parameter field, and use two bytes, and may occupy one or more bits in the two bytes.

Preferably, the method further includes: when the OLT waits until a wavelength switching process of the ONU is completed, keeping sending, by the OLT, a command for querying whether switching is completed, for example, a GATE² message in FIG. 6B, where the message is a unicast message, and is sent only to the ONU that responds to a wavelength switching command.

Specifically, FIG. 8 shows a specific embodiment of GATE message extension, as shown in FIG. 8. MPCP messages of a GATE type are classified into two types: a normal GATE MPCPDU and a discovery GATE MPCPDU. The GATE message implementing a wavelength switching function may have two implementation manners: one manner is that extension is performed based on the discovery GATE MPCPDU, as shown in the foregoing figure, a reserved bit of Discovery Information of the discovery GATE MPCPDU is extended, and any reserved bit is used to identify a purpose of the GATE message (that is, the GATE message is used for wavelength switching or is used for another purpose). When a value of the bit is 0, the bit identifies “for another purpose”, and when the value of the bit is 1, the bit identifies “for a wavelength switching message”. The other manner is self-defining a brand-new (third) GATE message: a WaveRegister GATE MPCPDU, as shown in a table below:

| Field name | Occupied byte |
|---|---|
| Destination Address | 6 |
| Source Address | 6 |
| Length/Type = 0 × 8808 | 2 |
| Opcode = 0 × 0010 | 2 |
| Timestamp | 4 |
| Number of grants/Flags | 1 |
| Grant #1 Start time | 4 |
| Grant #1 Length | 2 |
| Sync Time | 2 |
| WaveRegister Information | 2 |
| Pad/Reserved | 29 |
| FCS | 4 |

The Destination Address is used to identify a destination address, that is, an IP address to which a message is sent.

The Source Address is used to identify a source address, that is, an IP address from which the message is sent.

The Length/Type is used to identify a length or a type of the message.

The Opcode is used to identify an operation code of the message.

The Timestamp is used to identify a timestamp of the message.

The Number of grants/Flags is used to identify a grant number/identifier of the message.

The Grant #1 Start time is used to identify a grant start time of the message.

The Grant #1 Length is used to identify a grant length of the message.

The Sync Time is used to identify a synchronization time of the message.

To differentiate the message from an original GATE message, an operation code of the message may be set to 0x0010 for differentiation.

Optionally, another method may be further used to differentiate the message from the original GATE message. For example, an implementation manner is identifying by using the Number of grants/flags. FIG. 7B shows a definition of each byte in a Number of grants/flags field, where the third bit is referred to as Discovery, 0 represents a Normal GATE message, and 1 represents a Discovery GATE message. If the WaveRegister Information is added, the Flags may be extended from 8 bits to 16 bits, and two bits of the 16 bits are used to identify a type. For example, 00 represents a normal GATE, 01 represents a Discovery GATE, and 10 represents a WaveRegister Information message.

The WaveRegister Information is used to identify a purpose of the message, and a length of the field is two bytes, that is, 16 bits in total. For example, the first bit is selected to identify the purpose of the message, and when the first bit is 1, the first bit identifies that the message is used for wavelength switching, or when the first bit is 0, the first bit identifies that the message is used for another purpose. Certainly, another bit may also be used to identify.

The Pad/Reserved is used to identify a reserved field of the message.

The FCS is used to identify frame sequence check of the message.

FIG. 9a shows a specific embodiment of a Waveregister_req message, a Waveregister message, and a Waveregister_ack message, as shown in FIG. 9a. FIG. 9a shows a conventional MPCP frame format, and when the operation code Opcode is 0002, it represents that the frame is a GATE frame, or when the operation code is 0003, the frame is a REPORT frame, or when the operation code is 0004, the frame is a REGISTER_REQ frame, or when the operation code is 0005, the frame is a REGISTER frame, or when the operation code is 0006, the frame is a REGISTER_ACK frame. When the Operation codes Opcode is from 0007 to FFFD, the frame is a reserved field.

As shown in FIG. 9b, the reserved field of the OPCODE is used to extend a WaveREGISTER_REQ frame message, a WaveREGISTER frame message, and a WaveREGISTER_ACK frame message in this embodiment of the present disclosure. For example, the opcode=0007 represents the WaveREGISTER_REQ, the opcode=0008 represents the WaveREGISTER, and the opcode=0009 represents the WaveREGISTER_ACK.

FIG. 10 shows an embodiment used to support or implement an apparatus 1000 of the wavelength switching method shown in FIG. 6B. The apparatus 1000 includes a processing unit 1010 and a sending unit 1020. As shown in FIG. 10, the processing unit 1010 is configured to: encapsulate a logical link identifier LLID of an optical network unit ONU and a wavelength allocated to the ONU into a first Multi-Point Control Protocol MPCP message. The sending unit 1020 is configured to send the MPCP message to the ONU.

Further, the processing unit 1010 is further configured to send a second MPCP message to the ONU, where the second MPCP message carries an identifier instructing the optical network unit ONU to perform wavelength switching and wavelength switching window information.

Further, the apparatus 1000 further includes: a receiving unit 1030, configured to receive a response message of the second MPCP message, where the response message is carried in a third MPCP message, and the response message carries the logical link identifier LLID of the ONU.

The response message further carries current wavelength information of a laser of the ONU. The response message further carries at least one of the following information: a wavelength adjustable range of the laser of the ONU or a wavelength adjustment speed of the laser of the ONU.

Optionally, the sending unit 1020 is further configured to send a query message to the ONU, where the query message is carried in the third Multi-Point Control Protocol MPCP message, and is used to query whether the optical network unit ONU needs to perform wavelength switching, and the query message carries the wavelength switching window information.

The query message or the wavelength switching request message is sent by using a Multi-point Control Protocol MPCP frame format. An ONU identifier and information about the wavelength allocated to the ONU are set in a reserved field of the MPCP message.

For a frame structure of the MPCP message, reference may be made to the embodiment in the method embodiments, or reference may be made to the frame structure shown in FIG. 7, FIG. 8, and FIG. 9, which is not described in detail herein.

Specifically, the apparatus is expressed by using a physical entity, which may be a field-programmable gate array (FPGA), or may use an Application Specific Integrated Circuit (ASIC), or may use a system on chip (SoC), or may use a central processing unit (CPU), or may use a network processor (NP), or may use a digital signal processor (DSP), or may use a micro controller (MCU), or may use a programmable logic device (PLD) or another integrated chip.

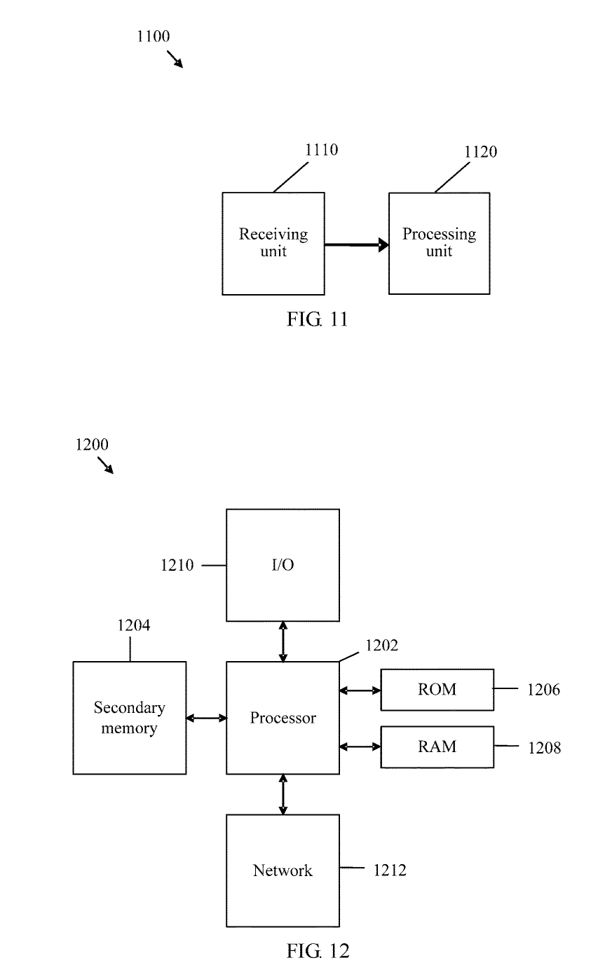

FIG. 11 shows an apparatus 1100 used to support or implement the embodiment of the wavelength switching method. The apparatus 1100 includes a receiving unit 1110 and a processing unit 1120. The receiving unit 1110 is configured to receive a first Multi-Point Control Protocol MPCP message sent by an optical line terminal OLT, where the first MPCP message carries a logical link identifier LLID of an optical network unit ONU and a wavelength allocated to the ONU.

The processing unit 1120 is configured to: determine whether the wavelength allocated to the ONU and a current wavelength of the ONU are the same, and if not, adjust the wavelength of the ONU to the wavelength allocated to the ONU.

Further, the receiving unit is further configured to receive a second MPCP message that is sent by the OLT and that instructs the ONU to perform wavelength switching; and the processing unit is further configured to: encapsulate the LLID of the ONU into a third Multi-Point Control Protocol MPCP message, and send the third MPCP message to the OLT.

The third MPCP message further carries a current wavelength of a laser of the ONU. The third MPCP message further carries at least one of the following information: a wavelength adjustable range of the laser of the ONU or a wavelength adjustment speed of the laser of the ONU.

Further, the apparatus 1100 further includes a sending unit 1130, configured to send a fourth MPCP message to the OLT, where the fourth MPCP message carries an adjusted wavelength of the ONU.

For a frame structure of the MPCP message, reference may be made to the embodiment in the method embodiments, or reference may be made to the frame structure shown in FIG. 7, FIG. 8, and FIG. 9, which is not described in detail herein.

Specifically, the apparatus is expressed by using a physical entity, which may be a field-programmable gate array (FPGA), or may use an Application Specific Integrated Circuit (ASIC), or may use a system on chip (SoC), or may use a central processing unit (CPU), or may use a network processor (NP), or may use a digital signal processor (DSP), or may use a micro controller (MCU), or may use a programmable logic device (PLD) or another integrated chip.

FIG. 12 shows a typical, general-purpose network component 1200 suitable for implementing one or more embodiments of the components and methods disclosed in this specification. The network component 1200 may include a processor 1202 (which may be referred to as a central processing unit or a CPU), and the processor communicates with storage apparatuses including the following: a secondary storage 1204, a read only memory (ROM) 1206, a random access memory (RAM) 1208, an input/output (I/O) apparatus 1210, and a network connection apparatus 1212. The processor 1202 may be implemented as one or more CPU chips, or may be part of one or more application specific integrated circuits (ASIC).

The network component 1200 may be applied to an OLT, or may be applied to an ONU.

The secondary storage 1204 generally includes one or more disk drives or tape drives and is configured to perform non-volatile storage on data, and if a capacity of the RAM 1208 is not large enough to store all working data, the secondary storage is used as an apparatus for storing overflow data. The secondary storage 1204 may be configured to store a program, and when the program is selected to be executed, the program is loaded into the RAM 1208. The ROM 1206 is configured to store an instruction and data that are read during program execution. The ROM 1206 is a non-volatile storage apparatus, which generally has a relatively small storage capacity relative to a larger storage capacity of the secondary storage 1204. The RAM 1208 is configured to store volatile data and may be further configured to store an instruction. Access to both the ROM 1206 and the RAM 1208 is generally faster than access to the secondary storage 1204.

When the apparatus 1200 runs an instruction in the memory, the processor performs the method steps in the method embodiments. For a specific process, reference may be made to the method embodiments, which is not described in detail herein.

An embodiment of the present disclosure further discloses an optical line terminal, including a processor and an optical module, where the processor may be the apparatus 1000 in the apparatus embodiments.

An embodiment of the present disclosure further discloses an optical network unit, including a processor and an optical-to-electrical converter, where the processor may be the apparatus 1100 in the apparatus embodiments.

An embodiment of the present disclosure further discloses a passive optical network system, including an OLT and an ONU as shown in FIG. 1, where the OLT includes the apparatus 1000 in the foregoing embodiment, or the ONU includes the apparatus 1100 in the foregoing embodiment, and when wavelength switching needs to be performed, the OLT and the ONU perform the method processes in the method embodiments.

This specification discloses at least one embodiment, and changes, combinations and/or modifications made by a person skilled in the art to the embodiments and/or the features of the embodiments fall within the scope of the present disclosure. Alternative embodiments generated by combination, integration and/or omission of the features of the embodiments also fall within the scope of the present disclosure. In a case in which numerical ranges or limitations are clearly stated, such expression ranges or limitations should be understood as including iterative ranges or limitations of similar magnitude falling within the clearly stated ranges or limitations (for example, from about 1 to about 10 includes 2, 3, 4, and so on; being greater than 0.10 includes 0.11, 0.12, 0.13, and so on). For example, whenever a numerical range with a lower limit R1 and an upper limit Ru is disclosed, any number falling within the range is specifically disclosed. With respect to any element of a claim, use of a term “optionally” means that the element is required, or the element is not required, and both alternatives fall within the scope of the claim. Use of broader terms such as comprising, including, and having should be understood as providing support for narrower terms such as consisting of, basically consisting of, and being substantially comprised of. Therefore, the protection scope is not limited by the foregoing descriptions but is defined by the appended claims, and the scope includes all equivalents of the subject matters of the appended claims. Each claim is incorporated in this specification as further disclosed content, and the appended claims are the embodiments of the present disclosure. It is not admitted that discussion of any reference in the disclosed content, especially any reference whose publication date is after the priority date of this application, is the prior art. Disclosed content of all patents, patent applications and publications cited in the present disclosure are hereby incorporated by reference, providing exemplary, procedural and other details supplementary for the present disclosure.

Although several embodiments have been provided in the present disclosure, it should be understood that the disclosed systems and methods may be embodied in many other specific forms without departing from the spirit or scope of the present disclosure. The examples of the present disclosure are should be considered to be illustrative but not restrictive, and the present disclosure is not limited to the details given in this specification. For example, the various elements or components may be combined or integrated in another system or some features may be omitted, or not implemented.

In addition, techniques, systems, subsystems, and methods described and illustrated in the various embodiments as to be discrete or separate may be combined or integrated with other systems, modules, techniques, or methods without departing from the scope of the present disclosure. Other items displayed or discussed as mutual coupling or direct coupling or communication may also be indirectly coupled or communicate electrically, mechanically, or in another form by using an interface, an apparatus or an intermediate component. Other examples with changes, substitutions, and alterations may be determined by a person skilled in the art and may be implemented without departing from the spirit and scope disclosed in this specification.

1. A wavelength switching method, comprising:
encapsulating a logical link identifier (LLID) of an optical network unit (ONU) and a wavelength allocated to the ONU into a first Multi-Point Control Protocol (MPCP) message; and
sending the first MPCP message to the ONU, for the ONU to perform switching according to the wavelength.

2. The method according to claim 1, further comprising:
sending a second MPCP message to the ONU, wherein the second MPCP message carries an identifier instructing the ONU to perform wavelength switching and wavelength switching window information.

3. The method according to claim 2, further comprising:
receiving a response message of the second MPCP message, wherein the response message is carried in a third MPCP message, and the response message carries the LLID of the ONU.

4. The method according to claim 3, wherein the response message further carries current wavelength information of a laser of the ONU.

5. The method according to claim 4, wherein the response message further carries at least one of the following information: a wavelength adjustable range of the laser of the ONU or a wavelength adjustment speed of the laser of the ONU.

6. A wavelength switching method, comprising:
receiving a first Multi-Point Control Protocol (MPCP) message sent by an optical line terminal (OLT), wherein the first MPCP message carries a logical link identifier (LLID) of an optical network unit (ONU) and a wavelength allocated to the ONU; and
determining whether the wavelength allocated to the ONU and a current wavelength of the ONU are the same, and if not, adjusting the wavelength of the ONU to the wavelength allocated to the ONU.

7. The method according to claim 6, wherein before the receiving the first MPCP message sent by the OLT, the method further comprises:
receiving a second MPCP message that is sent by the OLT and that instructs the ONU to perform wavelength switching, wherein the second MPCP message carries an identifier instructing the ONU to perform wavelength switching and wavelength switching window information; and
encapsulating the LLID of the ONU into a third MPCP message, and sending the third MPCP message to the OLT.

8. The method according to claim 7, wherein the third MPCP message further carries a current wavelength of a laser of the ONU.

9. The method according to claim 7, wherein the third MPCP message further carries at least one of the following information: a wavelength adjustable range of the laser of the ONU or a wavelength adjustment speed of the laser of the ONU.

10. The method according to claim 6, further comprising:
sending a fourth MPCP message to the OLT, wherein the fourth MPCP message carries an adjusted wavelength of the ONU.

11. A wavelength switching apparatus, comprising:
a processor configured to encapsulate a logical link identifier (LLID) of an optical network unit (ONU) and a wavelength allocated to the ONU into a first Multi-Point Control Protocol (MPCP) message; and
a transmitter configured to send the MPCP message to the ONU.

12. The apparatus according to claim 11, wherein the processor is further configured to send a second MPCP message to the ONU, wherein the second MPCP message carries an identifier instructing the ONU to perform wavelength switching and wavelength switching window information.

13. The apparatus according to claim 11, further comprising:
a receiver configured to receive a response message of the second MPCP message, wherein the response message is carried in a third MPCP message, and the response message carries the LLID of the ONU.

14. The apparatus according to claim 13, wherein the response message further carries current wavelength information of a laser of the ONU.

15. The apparatus according to claim 13, wherein response message further carries at least one of the following information: a wavelength adjustable range of the laser of the ONU or a wavelength adjustment speed of the laser of the ONU.

16. A wavelength switching apparatus, comprising:
a receiver configured to receive a first Multi-Point Control Protocol (MPCP) message sent by an optical line terminal (OLT), wherein the first MPCP message carries a logical link identifier (LLID) of an optical network unit (ONU) and a wavelength allocated to the ONU; and
a processor configured to: determine whether the wavelength allocated to the ONU and a current wavelength of the ONU are the same, and if not, adjust the wavelength of the ONU to the wavelength allocated to the ONU.

17. The apparatus according to claim 16, wherein:
the receiver is further configured to receive a second MPCP message that is sent by the OLT and that instructs the ONU to perform wavelength switching; and
the processor is further configured to: encapsulate the LLID of the ONU into a third MPCP message, and send the third MPCP message to the OLT.

18. The apparatus according to claim 17, wherein the third MPCP message further carries a current wavelength of a laser of the ONU.

19. The apparatus according to claim 17, wherein the third MPCP message further carries at least one of the following information: a wavelength adjustable range of the laser of the ONU or a wavelength adjustment speed of the laser of the ONU.

20. The apparatus according to claim 16, further comprising:
a transmitter configured to send a fourth MPCP message to the OLT, wherein the fourth MPCP message carries an adjusted wavelength of the ONU.

21. An optical line terminal, comprising:
a processor configured to encapsulate an optical network unit (ONU) identifier of an ONU whose wavelength needs to be switched and a wavelength allocated to the ONU into a first Multi-Point Control Protocol (MPCP) message, and send the first MPCP message to the ONU whose wavelength needs to be switched, for the ONU to perform switching according to the wavelength.

22. An optical network unit, comprising:
a processor configured to:
receive a second Multi-Point Control Protocol (MPCP) message, wherein the second MPCP message carries an optical network unit (ONU) identifier of the ONU whose wavelength needs to be switched and wavelength adjustment performance information of a laser of the ONU;
determine, according to the wavelength adjustment performance information of the laser of the ONU, the wavelength allocated to the ONU; and
encapsulate a logical link identifier (LLID) of the ONU and the determined wavelength allocated to the ONU into the first MPCP message, and send the first MPCP message to the ONU, for the ONU to perform switching according to the wavelength.

23. A passive optical network (PON) system, comprising:
an optical line terminal (OLT); and
an optical network unit (ONU),
wherein the OLT is connected to at least one ONU by using an optical distribution network (ODN),
wherein the OLT comprises the optical line terminal configured to:
encapsulate an ONU identifier of an ONU whose wavelength needs to be switched and a wavelength allocated to the ONU into a first Multi-Point Control Protocol (MPCP) message, and
send the first MPCP message to the ONU whose wavelength needs to be switched, for the ONU to perform switching according to the wavelength, and
wherein the ONU comprises the optical network unit, configured to:
receive a second MPCP message, wherein the second MPCP message carries the ONU identifier of the ONU whose wavelength needs to be switched and wavelength adjustment performance information of a laser of the ONU,
determine, according to the wavelength adjustment performance information of the laser of the ONU, the wavelength allocated to the ONU, and
encapsulate a logical link identifier (LLID) of the ONU and the determined wavelength allocated to the ONU into the first MPCP message, and send the first MPCP message to the ONU, for the ONU to perform switching according to the wavelength.
